(19) United States
(12) Patent Application Publication
(10) Pub. No.: US 2025/0166325 A1
(43) Pub. Date: May 22, 2025

(54) LEARNABLE DEFORMATION FOR POINT CLOUD SELF-SUPERVISED LEARNING

(71) Applicant: QUALCOMM Technologies, Inc., San Diego, CA (US)

(72) Inventors: Hongyu WU, Amsterdam (NL); Pengwan YANG, Amsterdam (NL); Yuki Markus ASANO, Amsterdam (NL); Cornelis Gerardus Maria SNOEK, Volendam (NL)

(21) Appl. No.: 18/744,541

(22) Filed: Jun. 14, 2024

Related U.S. Application Data
(60) Provisional application No. 63/600,513, filed on Nov. 17, 2023.

(51) Int. Cl. G06T 19/20; G06V 10/77; G06V 10/82

(52) U.S. Cl. CPC G06T 19/20; G06V 10/7715; G06V 10/82; G06T 2219/2021

(57) ABSTRACT

A processor-implemented method includes obtaining, with a backbone artificial neural network, an original feature map of point cloud data. The method also includes deforming the point cloud data, with a deformation artificial neural network, into a number of deformed point cloud objects based on the original feature map of point cloud data. The method further includes combining the deformed point cloud objects into a mixed point cloud. The method still further includes extracting, with the backbone artificial neural network, a mixed feature map from the mixed point cloud. The method includes extracting a number of deformed feature maps from the deformed point cloud objects. The method still further includes computing, with a contrastive module, a loss for the backbone artificial neural network and for the deformation artificial neural network based on the mixed feature map and the deformed feature maps.

### CROSS-REFERENCE TO RELATED APPLICATION

The present application claims the benefit of U.S. Provisional Patent Application No. 63/600,513, filed on Nov. 17, 2023, and titled “LEARNABLE DEFORMATION FOR POINT CLOUD SELF-SUPERVISED LEARNING,” the disclosure of which is expressly incorporated by reference in its entirety.

### FIELD OF THE DISCLOSURE

Aspects of the present disclosure generally relate to artificial neural networks and more specifically to point clouds and learnable deformation techniques for self-supervised learning.

### BACKGROUND

Artificial neural networks may comprise interconnected groups of artificial neurons (e.g., neuron models). The artificial neural network (ANN) may be a computational device or be represented as a method to be performed by a computational device. Convolutional neural networks (CNNs) are a type of feed-forward ANN. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

A point cloud is a set of points representing a three-dimensional (3D) object. In the field of computer vision, self-supervised learning (SSL) leverages unlabeled data, thereby circumventing the resource-intensive process of manual annotation. Self-supervised learning is gaining significance in the domain of two-dimensional (2D) images. Self-supervised point cloud representations would be desirable.

### SUMMARY

Aspects of the present disclosure are directed to an apparatus. The apparatus has one or more memories and one or more processors coupled to the one or more memory. The processor(s) is configured to obtain, with a backbone artificial neural network, an original feature map of point cloud data. The processor(s) is also configured to deform the point cloud data, with a deformation artificial neural network, into a number of deformed point cloud objects based on the original feature map of point cloud data. The processor(s) is further configured to combine the deformed point cloud objects into a mixed point cloud. The processor(s) is still further configured to extract, with the backbone artificial neural network, a mixed feature map from the mixed point cloud. The processor(s) is also configured to extract a number of deformed feature maps from the number of deformed point cloud objects. The processor(s) is still further configured to compute, with a contrastive module, a loss for the backbone artificial neural network and for the deformation artificial neural network based on the mixed feature map and the deformed feature maps.

In other aspects of the present disclosure, a processor-implemented method includes obtaining, with a backbone artificial neural network, an original feature map of point cloud data. The method also includes deforming the point cloud data, with a deformation artificial neural network, into a number of deformed point cloud objects based on the original feature map of point cloud data. The method further includes combining the deformed point cloud objects into a mixed point cloud. The method still further includes extracting, with the backbone artificial neural network, a mixed feature map from the mixed point cloud. The method also includes extracting a number of deformed feature maps from the deformed point cloud objects. The method still further includes computing, with a contrastive module, a loss for the backbone artificial neural network and for the deformation artificial neural network based on the mixed feature map and the deformed feature maps.

Aspects of the present disclosure are directed to an apparatus. The apparatus includes means for obtaining, with a backbone artificial neural network, an original feature map of point cloud data. The apparatus also includes means for deforming the point cloud data, with a deformation artificial neural network, into a number of deformed point cloud objects based on the original feature map of point cloud data. The apparatus further includes means for combining the deformed point cloud objects into a mixed point cloud. The apparatus still further includes means for extracting, with the backbone artificial neural network, a mixed feature map from the mixed point cloud. The apparatus also includes means for extracting a number of deformed feature maps from the deformed point cloud objects. The apparatus still further includes means for computing, with a contrastive module, a loss for the backbone artificial neural network and for the deformation artificial neural network based on the mixed feature map and the deformed feature maps.

In other aspects of the present disclosure, a non-transitory computer-readable medium with program code recorded thereon is disclosed. The program code is executed by a processor and includes program code to obtain, with a backbone artificial neural network, an original feature map of point cloud data. The program code also includes program code to deform the point cloud data, with a deformation artificial neural network, into a number of deformed point cloud objects based on the original feature map of point cloud data. The program code further includes program code to combine the deformed point cloud objects into a mixed point cloud. The program code still further includes program code to extract, with the backbone artificial neural network, a mixed feature map from the mixed point cloud. The program code also includes program code to extract a number of deformed feature maps from the deformed point cloud objects. The program code still further includes program code to compute, with a contrastive module, a loss for the backbone artificial neural network and for the deformation artificial neural network based on the mixed feature map and the deformed feature maps.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture that may modularize artificial intelligence (AI) functions, in accordance with aspects of the present disclosure.

FIG. 5 is a diagram illustrating a learnable free-form deformation network, in accordance with various aspects of the present disclosure.

FIG. 6 is a flow diagram illustrating a processor-implemented method for learnable deformation for point cloud self-supervised learning, in accordance with various aspects of the present disclosure.

### DETAILED DESCRIPTION

The detailed description set forth below, in connection the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

A point cloud is a set of points representing a three-dimensional (3D) object. In the field of computer vision, self-supervised learning (SSL) leverages unlabeled data, thereby circumventing the resource-intensive process of manual annotation. Self-supervised learning is gaining significance in the domain of two-dimensional (2D) images. Self-supervised point cloud representations would be desirable.

At the core of self-supervised learning for point clouds is the design of pretext tasks. Although existing models employ point cloud perturbation as a pretext task and reconstruct the original point in a self-supervised manner, in such models the learning procedure is static. Specifically, during weight updates in the feature extractor, the pretext remains static. To address this, aspects of the present disclosure introduce a dynamic procedure that adapts the pretext task during learning. The techniques of the present disclosure aim to identify new tasks that enable improved or even optimal deformation learning and high-level feature extraction in 3D point cloud contrastive learning. Further aspects of the present disclosure introduce a novel approach to constructing contrasts in contrastive learning. These aspects employ free-form deformation to facilitate the network in identifying optimal pathways for feature learning, effectively serving as a data-driven view generator. This dynamic approach ensures that the construction of contrastive pairs evolves along with the learning process, enhancing adaptability and performance in complex learning environments.

Aspects of the present disclosure propose an end-to-end learning-driven augmentation architecture that considers the shared features of the same class and the global information of the point cloud shape, while preserving the underlying structure of the point cloud data. The proposed architecture encompasses two distinct modules: a deformation module, and a contrastive learning module. The deformation module is tasked with generating deformation control points. When these points are applied to 3D objects, new deformed objects are obtained. The contrastive learning module ensures that the deformation parameters within the encoder are both learnable and optimizable based on the computed loss.

Particular aspects of the subject matter described in this disclosure can be implemented to realize one or more of the following potential advantages. In some examples, the described techniques of self-supervised learning for point clouds improves adaptability and performance in complex learning environments.

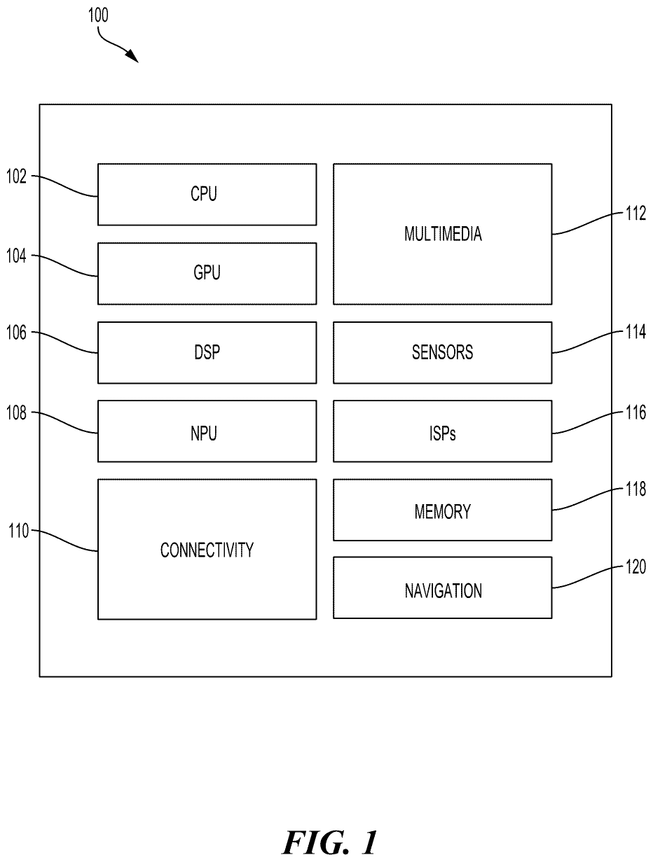

FIG. 1 illustrates an example implementation of a system-on-a-chip (SOC) 100, which may include a central processing unit (CPU) 102 or a multi-core CPU configured for self-supervised learning for point clouds. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In aspects of the present disclosure, the instructions loaded into the general-purpose processor 102 may include code obtain, with a backbone artificial neural network, an original feature map of point cloud data. The instructions loaded into the general-purpose processor 102 may include also code to deform the point cloud data, with a deformation artificial neural network, into multiple deformed point cloud objects based on the original feature map of point cloud data. The instructions loaded into the general-purpose processor 102 may further include code to combine the multiple deformed point cloud objects into a mixed point cloud. The instructions loaded into the general-purpose processor 102 may still further include code to extract, with the backbone artificial neural network, a mixed feature map from the mixed point cloud. The instructions loaded into the general-purpose processor 102 may also include code to extract multiple deformed feature maps from the multiple deformed point cloud objects. The instructions loaded into the general-purpose processor 102 may still further include code to compute, with a contrastive module, a loss for the backbone artificial neural network and for the deformation artificial neural network based on the mixed feature map and the multiple deformed feature maps.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

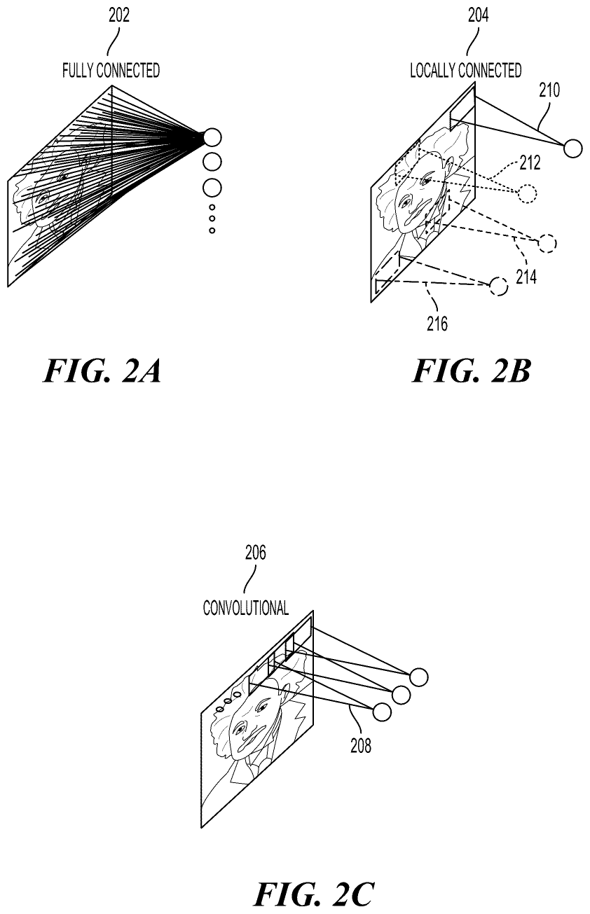

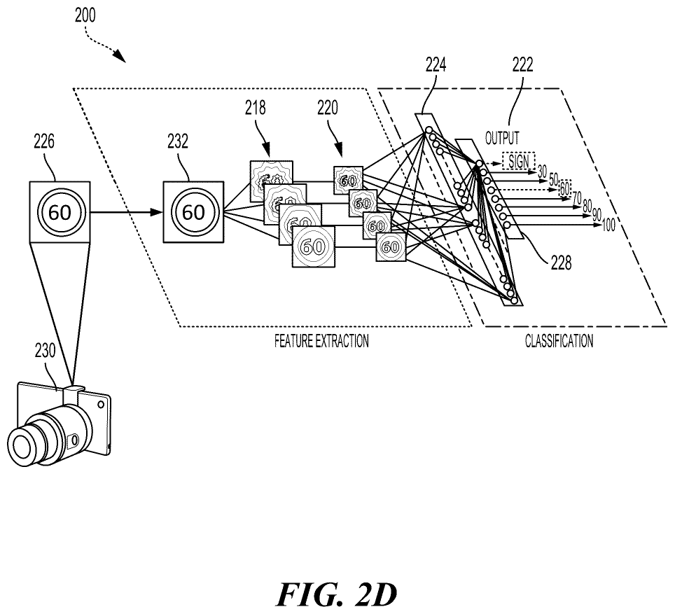

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

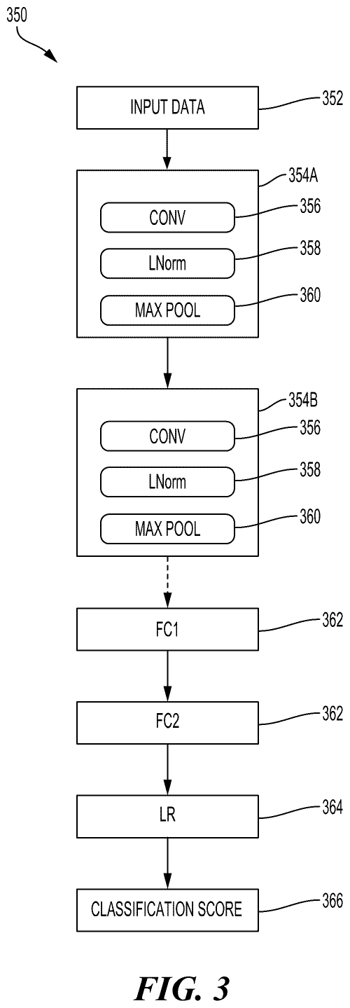

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

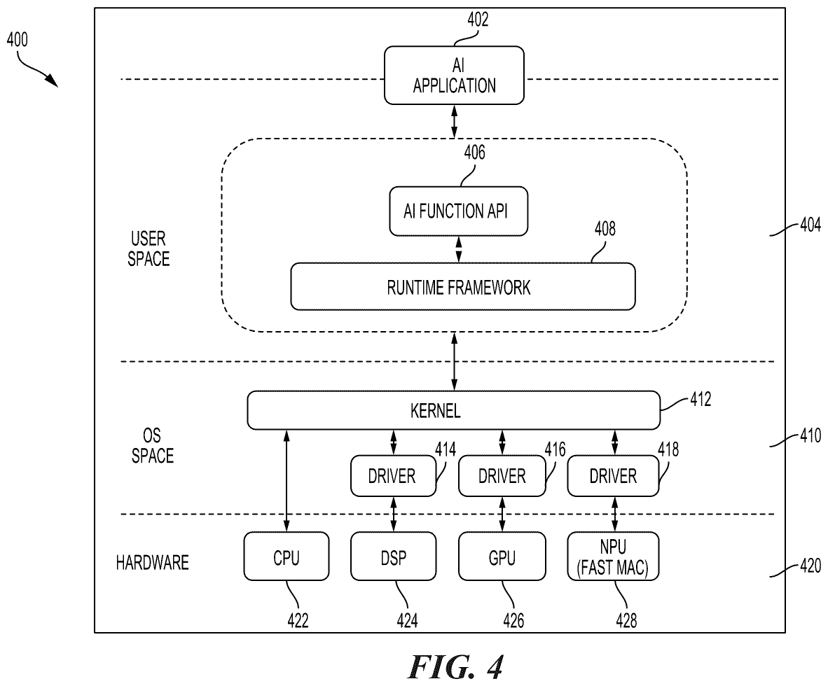

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to obtain, with a backbone artificial neural network, an original feature map of point cloud data for an AI application 402, according to aspects of the present disclosure. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to deform the point cloud data, with a deformation artificial neural network, into multiple deformed point cloud objects based on the original feature map of point cloud data. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to combine the multiple deformed point cloud objects into a mixed point cloud. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to extract, with the backbone artificial neural network, a mixed feature map from the mixed point cloud. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to extract multiple deformed feature maps from the multiple deformed point cloud objects. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to compute, with a contrastive module, a loss for the backbone artificial neural network and for the deformation artificial neural network based on the mixed feature map and the multiple deformed feature maps. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

In the field of computer vision, self-supervised learning (SSL) has emerged as a pivotal methodology. Self-supervised learning leverages the vast reservoirs of unlabeled data, thereby circumventing the resource-intensive process of manual annotation. Self-supervised learning is gaining significance in the domain of two-dimensional (2D) images. This learning paradigm can also be extended to the three-dimensional (3D) domain, where self-supervised learning has been shown to be effective for tasks such as point cloud classification segmentation, and 3D understanding. Self-supervised point cloud representations would be desirable.

At the core of self-supervised learning for point clouds is the design of pretext tasks. By training a model to solve pretext tasks, the model can be encouraged to learn useful features of point clouds. These features can then be transferred to downstream tasks such as classification, segmentation, and reconstruction. For instance, existing models reconstruct an occluded point cloud through an encoder-decoder architecture, whereas other models utilize a position and orientation to predict masked local geometric information of a point cloud. Although existing models employ point cloud perturbation as a pretext task and reconstruct the original point in a self-supervised manner, in such models, the learning procedure is static. Specifically, during weight updates in the feature extractor, the pretext remains static. To address this issue, aspects of the present disclosure introduce a dynamic procedure that adapts the pretext task during learning. The techniques of the present disclosure aim to identify new tasks that enable improved or even optimal deformation learning and high-level feature extraction in 3D point cloud contrastive learning. Further aspects of the present disclosure introduce a novel approach to the construction of contrasts in contrastive learning. These aspects employ free-form deformation to facilitate the network in identifying optimal pathways for feature learning, effectively serving as a data-driven view generator. This dynamic approach ensures that the construction of contrastive pairs evolves along with the learning process, enhancing adaptability and performance in complex learning environments.

Data augmentation plays an important role in the training of deep neural networks, enabling improvement of the model performance as well as its robustness. Within the context of point cloud data, the fundamental approach to data augmentation is achieved through a suite of techniques, with notable examples including affine transformations (such as translation, rotation, and scaling), random point drop, and random point perturbation (jittering). However, it is noteworthy that the deformation process is inherently multi-stage, and the exclusive application of localized deformation at the beginning impedes the model's ability to assimilate comprehensive global information from the current point cloud. Consequently, early stage localized deformation may lead to varying strategies for point clouds within the same class, thereby introducing potential semantic confusion to the model. Aspects of the present disclosure propose an end-to-end learning-driven augmentation strategy that considers the shared features of the same class and the global information of the point cloud shape, while preserving the underlying structure of the point cloud data.

According to aspects of the present disclosure, a training dataset is denoted as Sₙ={pᵢₖⁿ=1}, which contains the n points, where k is the class and i is the order of the point cloud. In the context of contrastive learning, a point cloud is denoted as P={pᵢ}ᵢ₌₁^{N} with pᵢ∈ [symbol] ³. The 3D object is transformed to generalize the two views pᵢt¹∈ [symbol] ³ and pᵢ^{t2}∈ [symbol] ³, where t1 and t2 correspond to the first transformation and the second transformation, to create additional unlabeled data for unsupervised learning. In the realm of deep learning, such a transformation is called data augmentation, which enhances model generalization by artificially expanding the training dataset through various transformations of the original data. Aspects of the present disclosure introduce a new data augmentation strategy for point cloud unsupervised learning.

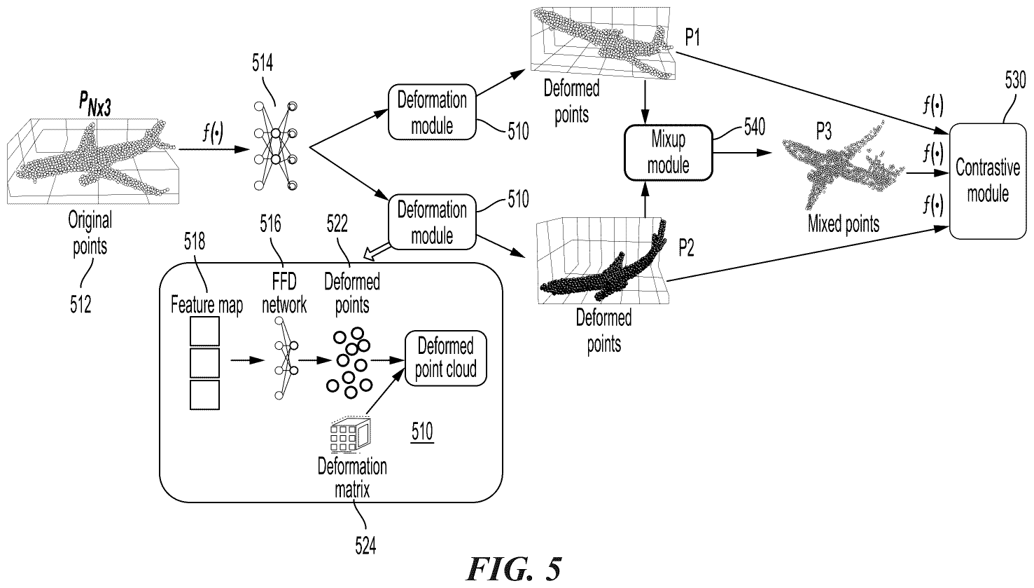

FIG. 5 is a diagram illustrating a learnable free-form deformation network, in accordance with various aspects of the present disclosure. In the example of FIG. 5, the proposed architecture encompasses two distinct modules: a deformation module 510, and a contrastive learning module 530. The deformation module 510 is tasked with generating deformation control points. When these points are applied to 3D objects, they yield new deformed objects. The contrastive learning module 530 ensures that the deformation parameters within the encoder are both learnable and optimizable based on the computed loss. A more detailed explanation of these modules is now presented.

The deformation module 510 creates a free-form deformation transformation f:p→R^{∥P∥}, where ∥P∥ represents the norm of the point cloud P. To be more specific, at first, an original point cloud 512 is fed to a backbone artificial neural network f(·) 514 to yield a feature map 518 F∈R^{∥P∥×D}, where D is the dimension of the feature. Next, the feature map 518 feeds into the deformation module 510, which may include a free-form deformation (FFD) network implemented as a multilayer perceptron (MLP) 516, to obtain the control points perturbation AC. As described in equation (2) below, the position of the original control points will be revised, leading to a deformation of the object. Although an MLP is described, other types of neural networks may alternatively be implemented, such as a free-form deformation (FFD) network.

To compute the control points perturbation, the feature map 518 of global features is obtained. For a point-based feature extractor, such as the PointNet architecture, through the order-invariant max pooling layer, the global feature G={g₁, g₂, . . . , g_{D}} is obtained. A free-form deformation (FFD) network, e.g., MLP 516, receives the feature map 518 of global features to create a mapping from point cloud feature G to control point perturbation 522, where the indexes i, j, and k denote the order of corresponding control points.

For a given point cloud P, the associated lattice space for free-form deformation (FFD) is determined by a Bernstein deformation matrix 524. Updated control points of a lattice, denoted as \tilde{C}, are derived through a direct summation process. Subsequently, a matrix multiplication is executed between the Bernstein deformation matrix 524 and these updated control points. Finally, the deformed point cloud P^{Tk} is obtained, where k denotes the k-th result obtained by the k-th deformation generator.

Further details of the proposed model are now presented. The learnable free-form deformation network learns to generate deformed point cloud objects P₁ and P₂. That is, the two deformation modules 510 of the deformation artificial neural network illustrated in FIG. 10 do not share weights, and thus produce the two different deformed point cloud objects P₁ and P₂. A saliency-guided mixup module 540 enhances the transformation by integrating the saliency of the two deformed variations P₁ and P₂ into a mixed point cloud P₃. The contrastive learning module 530 enables point cloud representation learning by utilizing the deformed and mixed point clouds P₁, P₂, and P₃.

Free-form deformation (FFD) is a technique for 3D graphics and modeling. Free-form deformation deforms an object based on manipulation of a lattice or grid that surrounds the object, while maintaining the local structure integrity of the 3D object. Free-form deformation does not manipulate the object directly but rather embeds the object in a space, and when the embedded space deforms, the object also deforms as the embedded space deforms. Let the three coordinate directions of the lattice space be (s, t, u), such that the deformed space Q(u, v, w) is:

$$Q ( u , v , w ) = {\sum }_{i = 0}^{l} {\sum }_{j = 0}^{m} {\sum }_{k = 0}^{n} {B}_{i , l} ( s ) {B}_{j , m} ( t ) {B}_{k , n} ( u ) {ℙ}_{ijk} , \qquad ( 1 )$$

where B is the Bernstein polynomial, [symbol] ᵢⱼₖ represents the control points of the lattice, and l, m, and n are the degrees of the lattice in the s, t, and u directions, respectively.

Transitioning to the domain of deep learning, free-form deformation can be parameterized in a manner conducive to learning, where the deform degree may be calculated and the object deformed in an effective way during the learning process. That is, a learnable form of equation (1) can be written as:

$$Q = B ( ℙ + Δ ℙ ) , \qquad ( 2 )$$

where B is the Bernstein deformation matrix, and ΔP is the parameterized control point perturbation. It is noted that the Bernstein deformation matrix is also referred to as the Bernstein polynomial. Notably, this method offers scalable performance with higher resolutions without using 3D convolutions, ensures precision by avoiding discretization, allows for generating point clouds of varying densities, and can infer a shape by deforming the Bernstein-decomposed vertices while preserving face connections.

After free-form deformation, a new deformation of the same object is generated. However, due to the nature of the free-form deformation, the deformations generated by different modules can be significantly different. The mixup module 540 combines commonality between two deformations as a strong regularizer. The mixup module 540 provides a linear interpolation to mathematically combine these views P₁ and P₂, creating a new representation P₃ that captures the essence of both parent views P₁ and P₂, as seen in equation (3):

$${P}_{3} = λ \cdot {P}_{1} + ( 1 - λ ) \cdot {P}_{2} , \qquad ( 3 )$$

where P₃ denotes the resultant mixed point cloud, P₁ and P₂ represent the two original point clouds, and A is a coefficient dictating the proportional contribution of each original point cloud to the mixed version, which is derived from a Beta distribution λ˜Beta(α, α).

As shown in FIG. 5, the P₃ mixup version (also referred to as the P^{T3} transform) is based on the deformed point clouds P₁ and P₂ (also referred to as the P^{T1} and P^{T2} transforms). The mixup module 540 serves as a potent form of regularization. By generating interpolated samples, the model is deterred from over fitting to specific features or artifacts inherent in a singular view. Instead, the model gravitates towards recognizing and prioritizing features consistently manifest across both views, fostering a focus on shared attributes.

Contrastive learning loss is now described. After extracting the global features from three distinct deformations of the point cloud, it becomes feasible to compute the loss for the optimization of both the backbone artificial neural network 514 and the free-form deformation (FFD) network 516. The PointInfoNCE (noise contrastive estimation) loss is specifically tailored for self-supervised learning scenarios involving point clouds. The PointInfoNCE loss facilitates the computation of the InfoNCE loss L_{NCE} from a point cloud-centric viewpoint, where:

$${L}_{NCE} = - log \frac{{\sum }_{( i , j ) ∈ Q} exp ( {f}_{i} \cdot {f}_{j} / τ )}{{\sum }_{( i , k ) ∈ Q} exp ( {f}_{i} \cdot {f}_{k} / τ )} , \qquad ( 4 )$$

and τ is a temperature parameter. Let P denote the set encompassing all positive correspondences between two views. Within this framework, attention is solely directed towards points possessing at least one correspondence, while points without matches are excluded from serving as negatives. For a given matched pair (i, j) that belongs to P, the point feature fᵢ functions as the query, whereas fⱼ acts as the positive key k+. The point feature fₖ, where there exists ∃(i, k)∃Q and k≠j, is designated as the set of negative keys.

In the proposed model, computations are conducted across three distinct point clouds. To effectively utilize the shared global information emanating from various deformations, an additional regularization term is introduced, such that the modified loss consists of:

$$L = 0.8 * {L}_{c} ( P 1 , P 2 ) 0.1 * {L}_{c} ( P 1 , P 3 ) 0. 1 * {L}_{c} ( P 2 , P 3 ) , \qquad ( 5 )$$

where L_{c} is the PointInfoNCE loss between two point clouds. In the paradigm of contrastive learning, the model endeavors to minimize a distance between similar samples in the embedding space while maximizing a distance between dissimilar samples. The introduction of the mixup module 540 amplifies this challenge, compelling the model to differentiate not only between distinct point clouds but also their mixed versions. The mixup module 540 causes the model to identify and rely on the most discriminative and shared features between the two views.

The different deformation modules 510 do not share their weights. However, in the training process, due to the parameter model being optimized towards a lower cost function, the deformation modules 510 tend to have similar functions in the end. To prevent this similarity, the free-form deformation (FFD) network 516 may be regularized in the deformation modules 510. The Chamfer distance is a widely used distance metric for two-point cloud similarity. The Chamfer distance λ between two point clouds A and B is defined as:

$${L}_{Cham} = \frac{1}{\vert {P}_{1} \vert} {\sum }_{a ∈ {P}_{1}} {min}_{b ϵ {P}_{2}} {‖ a - b ‖}^{2} + \frac{1}{\vert {P}_{2} \vert} {\sum }_{b ∈ {P}_{2}} {min}_{a ϵ {P}_{1}} {‖ a - b ‖}^{2} , \qquad ( 6 )$$

where: |A| and | B| are the cardinalities of the point sets A and B, respectively, and ∥a−b∥ denotes the Euclidean distance between points a and b. Therefore, the final loss L_{final} is computed as:

$${L}_{final} = L ( {P}^{T 1} , {P}^{T 3} , {P}^{T 2} ) - λ ( {P}^{T 1} + {P}^{T 2} ) \qquad ( 7 )$$

The negative sign in the regularization term ensures the model is penalized if the Chamfer distance between the two free-form deformations is small, e.g., if they are similar. As the training progresses, the model will be encouraged to produce free-form deformations that are distinct from each other. By introducing the Chamfer distance, the model is encouraged to generate diverse free-form deformations, which can be beneficial in capturing a wider range of features and variations in the point cloud data. Although the example is described with respect to the Chamfer distance, other distances can be substituted for the Chamfer distance.

Aspects of the present disclosure introduce three main concepts. Current self-supervised learning methods for point clouds typically use local/partial regions of the point cloud as augmentation for contrast, which can easily introduce bias and noise. Aspects of the present disclosure learn the overall/global deformations of point clouds as augmentation for point cloud self-supervised learning. The learnable free-form deformation network 516 learns to generate deformed point cloud objects. The saliency-guided mixup module 540 enhances the deformation by integrating the saliency of two deformed variations. The contrastive learning module 530 enables optimizing (or improving) the backbone artificial neural network 514 and the free-form deformation network 516 based on a computed loss.

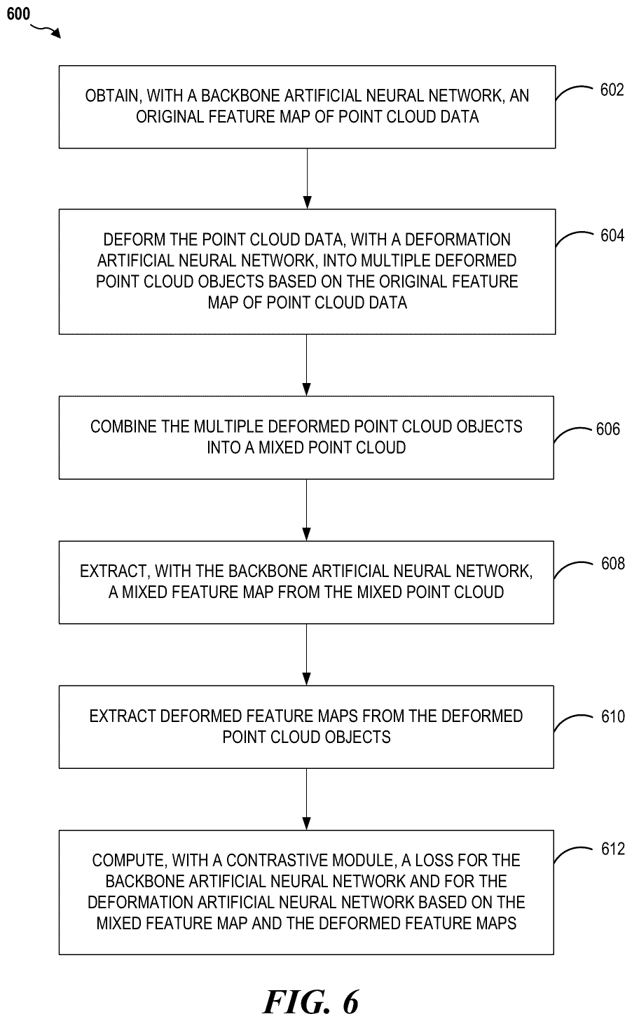

FIG. 6 is a flow diagram illustrating a processor-implemented method 600 for learnable deformation for point cloud self-supervised learning, in accordance with various aspects of the present disclosure and as seen in FIG. 5. The processor-implemented method 600 may be performed by one or more processors such as the CPU (e.g., 102, 422), GPU (e.g., 104, 426), and/or other processing unit (e.g., DSP 424, NPU 428), for example. The process may run in real time with an inference engine. During idle time, online training may be performed to update the model. The process may be used in vehicles, may receive point clouds from a vehicle, and/or may receive point clouds from an extended reality (XR) device.

As shown in FIG. 6, in some aspects, the processor-implemented method 600 may include obtaining, with a backbone artificial neural network, an original feature map of point cloud data (block 602). For example, a backbone artificial neural network f(·) may yield a feature map F∈R^{∥P∥×D}, where D is the dimension of the feature.

In some aspects, the processor-implemented method 600 may include deforming the point cloud data, with a deformation artificial neural network, into multiple deformed point cloud objects based on the original feature map of point cloud data (block 604). The deformation artificial neural network may be a multilayer perceptron (MLP). Different instances of the deformation artificial neural network may be trained differently to learn different deformations.

In some aspects, the processor-implemented method 600 may include combining the multiple deformed point cloud objects into a mixed point cloud (block 606). For example, the process may combine the deformed point cloud objects by performing linear interpolation between the deformed point cloud objects.

In some aspects, the processor-implemented method 600 may include extracting, with the backbone artificial neural network, a mixed feature map from the mixed point cloud (block 608). The processor-implemented method 600 may also include extracting deformed feature maps from the deformed point cloud objects (block 610).

In some aspects, the processor-implemented method 600 may include computing, with a contrastive module, a loss for the backbone artificial neural network and for the deformation artificial neural network based on the mixed feature map and the multiple deformed feature maps (block 612). For example, the process may compute the loss based on a regularization that penalizes similarity between the deformed point cloud objects.

### Example Aspects

Aspect 1: An apparatus, comprising: one or more memories; and one or more processors coupled to the one or more memories and configured to: obtain, with a backbone artificial neural network, an original feature map of point cloud data; deform the point cloud data, with a deformation artificial neural network, into a plurality of deformed point cloud objects based on the original feature map of point cloud data; combine the plurality of deformed point cloud objects into a mixed point cloud; extract, with the backbone artificial neural network, a mixed feature map from the mixed point cloud; extract a plurality of deformed feature maps from the plurality of deformed point cloud objects; and compute, with a contrastive module, a loss for the backbone artificial neural network and for the deformation artificial neural network based on the mixed feature map and the plurality of deformed feature maps.

Aspect 2: The apparatus of Aspect 1, in which the deformation artificial neural network comprises a multilayer perceptron.

Aspect 3: The apparatus of Aspect 1 or 2, in which the one or more processors is further configured to combine the plurality of deformed point cloud objects by performing linear interpolation between the plurality of deformed point cloud objects.

Aspect 4: The apparatus of any of the preceding Aspects, in which the one or more processors is further configured to deform the point cloud data by mapping each point cloud feature of the original feature map of point cloud data to a control point perturbation to obtain a set of control point perturbations in a lattice and to deform the lattice.

Aspect 5: The apparatus of any of the preceding Aspects, in which the one or more processors is further configured to optimize the backbone artificial neural network and the deformation artificial neural network based on the loss.

Aspect 6: The apparatus of any of the preceding Aspects, in which the one or more processors is further configured to compute the loss based on a regularization that penalizes similarity between the plurality of deformed point cloud objects.

Aspect 7: The apparatus of any of the preceding Aspects, in which the deformation artificial neural network comprises two instances of an artificial neural network.

Aspect 8: A processor-implemented method, comprising: obtaining, with a backbone artificial neural network, an original feature map of point cloud data; deforming the point cloud data, with a deformation artificial neural network, into a plurality of deformed point cloud objects based on the original feature map of point cloud data; combining the plurality of deformed point cloud objects into a mixed point cloud; extracting, with the backbone artificial neural network, a mixed feature map from the mixed point cloud; extracting a plurality of deformed feature maps from the plurality of deformed point cloud objects; and computing, with a contrastive module, a loss for the backbone artificial neural network and for the deformation artificial neural network based on the mixed feature map and the plurality of deformed feature maps.

Aspect 9: The processor-implemented method of Aspect 8, in which the deformation artificial neural network comprises a multilayer perceptron.

Aspect 10: The processor-implemented method of Aspect 8 or 9, further comprising combining the plurality of deformed point cloud objects by performing linear interpolation between the plurality of deformed point cloud objects.

Aspect 11: The processor-implemented method of any of the Aspects 8-10, further comprising deforming the point cloud data by mapping each point cloud feature of the original feature map of point cloud data to a control point perturbation to obtain a set of control point perturbations in a lattice and to deform the lattice.

Aspect 12: The processor-implemented method of any of the Aspects 8-11, further comprising optimizing the backbone artificial neural network and the deformation artificial neural network based on the loss.

Aspect 13: The processor-implemented method of any of the Aspects 8-12, further comprising computing the loss based on a regularization that penalizes similarity between the plurality of deformed point cloud objects.

Aspect 14: The processor-implemented method of any of the Aspects 8-13, in which the deformation artificial neural network comprises two instances of an artificial neural network.

Aspect 15: A non-transitory computer-readable medium having program code recorded thereon, the program code executed by a processor and comprising: program code to obtain, with a backbone artificial neural network, an original feature map of point cloud data; program code to deform the point cloud data, with a deformation artificial neural network, into a plurality of deformed point cloud objects based on the original feature map of point cloud data; program code to combine the plurality of deformed point cloud objects into a mixed point cloud; program code to extract, with the backbone artificial neural network, a mixed feature map from the mixed point cloud; program code to extract a plurality of deformed feature maps from the plurality of deformed point cloud objects; and program code to compute, with a contrastive module, a loss for the backbone artificial neural network and for the deformation artificial neural network based on the mixed feature map and the plurality of deformed feature maps.

Aspect 16: The non-transitory computer-readable medium of Aspect 15, in which the deformation artificial neural network comprises a multilayer perceptron.

Aspect 17: The non-transitory computer-readable medium of Aspect 15 or 16, further comprising program code to combine the plurality of deformed point cloud objects by performing linear interpolation between the plurality of deformed point cloud objects.

Aspect 18: The non-transitory computer-readable medium of any of the Aspects 15-17, further comprising program code to deform the point cloud data by mapping each point cloud feature of the original feature map of point cloud data to a control point perturbation to obtain a set of control point perturbations in a lattice and to deform the lattice.

Aspect 19: The non-transitory computer-readable medium of any of the Aspects 15-18, further comprising program code to optimize the backbone artificial neural network and the deformation artificial neural network based on the loss.

Aspect 20: The non-transitory computer-readable medium of any of the Aspects 15-19, further comprising program code to compute the loss based on a regularization that penalizes similarity between the plurality of deformed point cloud objects.

Aspect 21: An apparatus, comprising: means for obtaining, with a backbone artificial neural network, an original feature map of point cloud data; means for deforming the point cloud data, with a deformation artificial neural network, into a plurality of deformed point cloud objects based on the original feature map of point cloud data; means for combining the plurality of deformed point cloud objects into a mixed point cloud; means for extracting, with the backbone artificial neural network, a mixed feature map from the mixed point cloud; means for extracting a plurality of deformed feature maps from the plurality of deformed point cloud objects; and means for computing, with a contrastive module, a loss for the backbone artificial neural network and for the deformation artificial neural network based on the mixed feature map and the plurality of deformed feature maps.

Aspect 22: The apparatus of Aspect 21, in which the deformation artificial neural network comprises a multilayer perceptron.

Aspect 23: The apparatus of Aspect 21 or 22, further comprising means for combining the plurality of deformed point cloud objects by performing linear interpolation between the plurality of deformed point cloud objects.

Aspect 24: The apparatus of any of the Aspects 21-23, further comprising means for deforming the point cloud data by mapping each point cloud feature of the original feature map of point cloud data to a control point perturbation to obtain a set of control point perturbations in a lattice and to deform the lattice.

Aspect 25: The apparatus of any of the Aspects 21-24, further comprising means for optimizing the backbone artificial neural network and the deformation artificial neural network based on the loss.

Aspect 26: The apparatus of any of the Aspects 21-25, further comprising means for computing the loss based on a regularization that penalizes similarity between the plurality of deformed point cloud objects.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. An apparatus, comprising:
one or more memories; and
one or more processors coupled to the one or more memories and configured to:
obtain, with a backbone artificial neural network, an original feature map of point cloud data;
deform the point cloud data, with a deformation artificial neural network, into a plurality of deformed point cloud objects based on the original feature map of point cloud data;
combine the plurality of deformed point cloud objects into a mixed point cloud;
extract, with the backbone artificial neural network, a mixed feature map from the mixed point cloud;
extract a plurality of deformed feature maps from the plurality of deformed point cloud objects; and
compute, with a contrastive module, a loss for the backbone artificial neural network and for the deformation artificial neural network based on the mixed feature map and the plurality of deformed feature maps.

2. The apparatus of claim 1, in which the deformation artificial neural network comprises a multilayer perceptron.

3. The apparatus of claim 1, in which the one or more processors is further configured to combine the plurality of deformed point cloud objects by performing linear interpolation between the plurality of deformed point cloud objects.

4. The apparatus of claim 1, in which the one or more processors is further configured to deform the point cloud data by mapping each point cloud feature of the original feature map of point cloud data to a control point perturbation to obtain a set of control point perturbations in a lattice and to deform the lattice.

5. The apparatus of claim 1, in which the one or more processors is further configured to optimize the backbone artificial neural network and the deformation artificial neural network based on the loss.

6. The apparatus of claim 5, in which the one or more processors is further configured to compute the loss based on a regularization that penalizes similarity between the plurality of deformed point cloud objects.

7. The apparatus of claim 1, in which the deformation artificial neural network comprises two instances of an artificial neural network.

8. A processor-implemented method, comprising:
obtaining, with a backbone artificial neural network, an original feature map of point cloud data;
deforming the point cloud data, with a deformation artificial neural network, into a plurality of deformed point cloud objects based on the original feature map of point cloud data;
combining the plurality of deformed point cloud objects into a mixed point cloud;
extracting, with the backbone artificial neural network, a mixed feature map from the mixed point cloud;
extracting a plurality of deformed feature maps from the plurality of deformed point cloud objects; and
computing, with a contrastive module, a loss for the backbone artificial neural network and for the deformation artificial neural network based on the mixed feature map and the plurality of deformed feature maps.

9. The processor-implemented method of claim 8, in which the deformation artificial neural network comprises a multilayer perceptron.

10. The processor-implemented method of claim 8, further comprising combining the plurality of deformed point cloud objects by performing linear interpolation between the plurality of deformed point cloud objects.

11. The processor-implemented method of claim 8, further comprising deforming the point cloud data by mapping each point cloud feature of the original feature map of point cloud data to a control point perturbation to obtain a set of control point perturbations in a lattice and to deform the lattice.

12. The processor-implemented method of claim 8, further comprising optimizing the backbone artificial neural network and the deformation artificial neural network based on the loss.

13. The processor-implemented method of claim 12, further comprising computing the loss based on a regularization that penalizes similarity between the plurality of deformed point cloud objects.

14. The processor-implemented method of claim 8, in which the deformation artificial neural network comprises two instances of an artificial neural network.

15. A non-transitory computer-readable medium having program code recorded thereon, the program code executed by one or more processors and comprising:
program code to obtain, with a backbone artificial neural network, an original feature map of point cloud data;
program code to deform the point cloud data, with a deformation artificial neural network, into a plurality of deformed point cloud objects based on the original feature map of point cloud data;
program code to combine the plurality of deformed point cloud objects into a mixed point cloud;
program code to extract, with the backbone artificial neural network, a mixed feature map from the mixed point cloud;
program code to extract a plurality of deformed feature maps from the plurality of deformed point cloud objects; and
program code to compute, with a contrastive module, a loss for the backbone artificial neural network and for the deformation artificial neural network based on the mixed feature map and the plurality of deformed feature maps.

16. The non-transitory computer-readable medium of claim 15, in which the deformation artificial neural network comprises a multilayer perceptron.

17. The non-transitory computer-readable medium of claim 15, further comprising program code to combine the plurality of deformed point cloud objects by performing linear interpolation between the plurality of deformed point cloud objects.

18. The non-transitory computer-readable medium of claim 15, further comprising program code to deform the point cloud data by mapping each point cloud feature of the original feature map of point cloud data to a control point perturbation to obtain a set of control point perturbations in a lattice and to deform the lattice.

19. The non-transitory computer-readable medium of claim 15, further comprising program code to optimize the backbone artificial neural network and the deformation artificial neural network based on the loss.

20. The non-transitory computer-readable medium of claim 15, further comprising program code to compute the loss based on a regularization that penalizes similarity between the plurality of deformed point cloud objects.
